(19) United States
(12) Patent Application Publication
(10) Pub. No.: US 2008/0156329 A1
(43) Pub. Date: Jul. 3, 2008

(54) Cartridge Respirator with Integral Filter Adaptor

(76) Inventors: Ronald L. Gerson, Carlisle, MA (US); Robert A. Brunell, Forestdale, MA (US)

Correspondence Address: BROMBERG & SUNSTEIN LLP, 125 SUMMER STREET, BOSTON, MA, 02110-1618, US

(21) Appl. No.: 11/619,422

(22) Filed: Jan. 3, 2007

(51) Int. Cl. A62B 7/10

(52) U.S. Cl. 128/206.12

(57) ABSTRACT

A respirator system has a vapor filter which includes a body for holding a vapor filter media, a first integral male connector for attachment to a particle filter, and a second integral female connector on an opposing side for connecting to a respirator mask. The particle filter has a complementary female connector and the mask has a complementary male connector for attachment to the vapor filter body. Alternately, a circumferential lip of the vapor filter and a sealing surface or a retainer sealingly attach a particle filter pad to the vapor filter. A method of assembly includes providing a vapor filter with an integral connector for attaching to a particle filter, providing a complementary connector and connecting the vapor filter to the particle filter.

### TECHNICAL FIELD

The present invention generally relates to respirators, and more particularly, for filters used with respirators.

### BACKGROUND ART

Respirators remove particles and vapors from the air inhaled by an exposed person. To that end, a respirator may have different types of coupled filter devices to filter the air. For example, a respirator may have activated charcoal cartridges to filter specified types vapors, and/or particle filters, such as HEPA filters (high efficiency particulate air filters), to filter specified types of particles. Respirator masks and filters generally are certified by NIOSH (National Institute for Occupational Safety and Health,) a division of the CDC (Centers for Disease Control & Prevention,) a United States government agency, under the regulations and requirements of 42 CFR Part 84. Under this regulation, particulate filters for air-purifying respirators may be approved in one or more of nine categories of filter efficiency. These categories are divided into filters suitable for use with solid particulates only (non-oil aerosol environment), called “N” series filters, and filters for use with both solid and/or oil particulates, called “R” or “P” series filters, depending upon whether the filters are oil resistant or oil proof Within the categories “N”, “R” and “P”, filters may then be approved for three levels of filter efficiency: 95%, 99% or 99.97%. The NIOSH protocol detailed in Part 84.181 is used to test filter efficiency of non-powered air purifying respirators. Under this protocol, atomized sodium chloride is used to test the efficiency of N-series filters. This atomized sodium chloride test aerosol is required to have a particle size distribution with count median diameter of 0.075±0.020 micrometer and a standard geometric deviation not exceeding 1.86 at the specified test conditions. For testing of “R” or “P” series filters, a neat cold-nebulized dioctyl phthalate (DOP) or equivalent aerosol with a particle size distribution with count median diameter of 0.185±0.20 micrometer and a standard geometric deviation not exceeding 1.60 at the specified test conditions is used. For example, a P100 (so called “HEPA” filter) is certified by NIOSH to filter at least 99.97% of the nebulized DOP particles under the conditions of the test protocol.

Proper connection between the respirator and coupled filters is particularly important for protection of the user. Typically, a particle filter can be sufficiently press-fitted by means of a retaining ring to the surface of a vapor-protecting cartridge to meet the certification requirements for a particle filter of 95 or 99% filter efficiency in any of the “N” “R” or “P” series. However, because it is generally more difficult to filter oil aerosols, and because a 100-class filter may only allow a leakage of 0.03 of 1% of the nebulized DOP test challenge, to ensure compliance, “P 100” filter are often factory pre-attached to a chemical cartridge before sale. If not sold pre-assembled, the field assembly of a P 100 filter usually requires the use of a specially gasketed adaptor, which is non-removably fitted to the chemical cartridge and contains a threaded opening for the P 100 filter. Such specially gasketed adaptors are expensive and, being an additionally required part, are inconvenient to use.

### SUMMARY OF THE INVENTION

A first embodiment of the invention provides a respirator cartridge having a body for holding vapor filter media. The body has an integral filter connector for connecting with a particle filter.

Both the respirator cartridge and the particle filter may be “quick-connect” filters that have quick-connect filter connectors. The body of the respirator cartridge may also include an integral mask connector, which allows the cartridge to be readily connected with a respirator mask. The mask connector may also be a quick-connect filter connector. The connectors may have a polarity; for example, the filter connector may be a male connector and the mask connector may be a female connector. A gasket may be provided for sealing the body to the particle filter, when connected.

In other embodiments of the invention, the filter connector is disposed on a first side of the body and the mask connector is disposed on a second side of the body. Both the male and female connectors may be integral to the cartridge. The first and second sides of the body may be opposingly located. The body may be constructed from a first piece and a second piece. Both the first and second pieces may include internal ridges for compressingly holding the vapor filter media and for increasing potential air flow paths. The first piece may include the male connector and the second piece may include a female connector.

In other embodiments of the invention, a circumferential lip of the respirator cartridge receives a particle filter. Co-circumferential attachment of the particle filter to the lip ensures that air flowing through the first side of the body passes through the particle filter. The lip may be structured to receive a particle filter retainer that has a central air passage, a circumferential sealing surface, and a locking feature. The central air passage allows air to flow through the retainer and to the particle filter and vapor filter cartridge. The circumferential sealing surface seals the particle filter to the lip. The locking feature secures the filter cartridge retainer to the respirator cartridge.

The respirator cartridge body may be constructed from an injection molded thermoplastic material, and may include male and female bayonet mount structures The respirator cartridge may include a concave surface surrounding the bayonet structure to increase the size of an air gap formed when a filter pad is securely positioned above the bayonet structure.

The male bayonet mount structure may include a projecting cylindrical member with a central aperture that allows the flow of fluid, such as air, in an axial direction therethrough. The flow of fluid in the axial direction may occur when the bayonet mount is in either a coupled or an uncoupled state. The cylindrical member may also have an opening in its side wall for allowing the flow of fluid in a direction transverse to the axial direction when the mount is not coupled to a female bayonet mount (such as when the cartridge is used with a filter pad). However, the opening may be sealingly occluded by a complementary female bayonet structure (e.g., of a quick-connect particle filter) so that flow of fluid is through the central aperture only.

In yet another an embodiment of the invention, a respirator mask filter system includes a vapor filter cartridge having a body with a first integral connector, and a particle filter, the particle filter having a second integral connector. The first and second integral connectors are removably connectable.

In a further embodiment of the invention, a method provides a particle filter and a cartridge with a body for holding vapor filter media. The body has a first integral connector, while the particle filter has a second integral connector. The first and second integral connectors are attached to establish fluid communication between the cartridge and the particle filter.

In another embodiment, a particle filter includes a particle filtration medium sealed to an integral female connector that is adapted for attachment to a male connector of a vapor cartridge. The female connector has a flange that sealingly seats against the vapor filter cartridge when the particle filter and vapor filter cartridge are connected.

### BRIEF DESCRIPTION OF THE DRAWINGS

The foregoing advantages of the invention will be appreciated more fully from the following further description thereof with reference to the accompanying drawings. Below is a brief description of the drawings.

FIG. 1 schematically shows a user wearing a half-mask respirator;

FIG. 2 schematically shows a front-view of a half-mask respirator;

FIG. 3a schematically shows a front view of a quick-connect particle filter;

FIG. 3b schematically shows a back view of a quick-connect particle filter;

FIG. 4a schematically shows a top perspective view of a vapor filter cartridge;

FIG. 4b schematically shows a bottom perspective view of a vapor filter cartridge;

FIG. 5 schematically shows a respirator mask with two attached vapor filter cartridges;

FIG. 6 schematically shows a particle filter pad;

FIG. 7 schematically shows a particle filter-pad retainer;

FIG. 8 schematically shows a combined vapor and particle filtration assembly, which includes a vapor filter cartridge, a filter pad, and a retainer;

FIG. 9 schematically shows a front view of a mask with two attached combined vapor and particle filtration assemblies;

FIG. 10 schematically shows an exploded view of a mask configured in accordance with illustrative embodiments of the invention;

FIG. 11 schematically shows an exploded view of a mask with quick-connect vapor cartridges, filter pads, and retainers, in accordance with another embodiment of the invention;

FIG. 12a schematically shows a sectional view of an unassembled quick-connect vapor filter and quick-connect particle filter in accordance with illustrative embodiments of the invention;

FIG. 12b schematically shows a sectional view of an assembled quick-connect vapor filter and quick-connect particle filter in accordance with illustrative embodiments of the invention;

FIG. 13a schematically shows a sectional view of an unassembled quick-connect vapor filter and quick-connect particle filter having an integral sealing flange in accordance with illustrative embodiments of the invention;

FIG. 13b schematically shows a sectional view of an assembled quick-connect vapor filter and quick-connect particle filter having an integral sealing flange in accordance with illustrative embodiments of the invention;

FIG. 14 schematically shows a sectional view of an unassembled quick-connect vapor filter, particle filter pad, and retainer in accordance with illustrative embodiments of the invention;

FIG. 15 schematically shows a sectional view of an assembled quick-connect vapor filter, particle filter pad, and retainer in accordance with illustrative embodiments of the invention;

FIG. 16 schematically shows a bottom view of a quick-connect vapor filter assembled with a quick-connect particle filter in accordance with illustrative embodiments of the invention;

FIG. 17 schematically shows a top view of an upper-piece of a quick-connect particle filter housing in accordance with illustrative embodiments of the invention;

FIG. 18 schematically shows a bottom view of the upper piece of a quick-connect particle filter housing shown in FIG. 17;

FIG. 19 schematically shows a sectional view of a male connector with bayonets.

### DETAILED DESCRIPTION OF SPECIFIC EMBODIMENTS

In illustrative embodiments of the invention, a particle and/or vapor-filtration respirator mask system has an integral coupling apparatus to easily connect and disconnect a particle filter. Specifically, the system includes a respirator mask with at least one inhalation port that is removably connectable to a particle filter, vapor filter, or combination thereof The vapor filter has an integral connector for rapid, facile attachment to a particle filter. Embodiments of the invention may be assembled for used by connecting only two or three pieces and thus, is convenient to store, transport, and use, and may also provide a manufacturing cost or retail price advantage.

More specifically, in some embodiments of the invention, a vapor filter has a body and two connectors: a first connector for connecting the body to a port on a respirator mask, and a second connector for connecting the body to a particle filter. The connectors may be any of a variety of connectors known in the art, including threaded connectors or snap-on connectors. Using a reversible connector, such as those mentioned herein, adds the advantage of allowing a user to easily disconnect and replace one or more used, damaged, or defective filters, and to reuse the mask. For improved convenience, the system may use a quick-connect (or quick-disconnect) connector, which typically allows attachment or detachment of a filter with one or two simple hand motions (e.g., insertion and a twist of about −45°). This category of connectors also may include bayonet mounts similar to those used for removably attaching a lens to a camera with a simple insertion and rotation. Bayonet mounts typically have pins (bayonets), which play in and out of holes made to receive them, and which thus serve to engage or disengage parts. In some embodiments, the particle filter includes an integral connector for connecting to the body. Alternately, the particle filter may be overlaid atop the body and secured with a retainer.

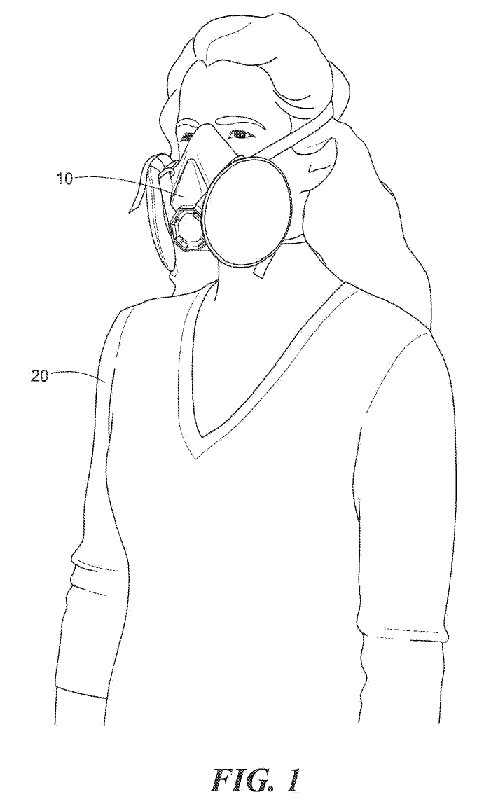

FIG. 1 shows a user 20 wearing a respirator mask 10 (also referred to as a “mask 10”) that may couple with a filter system configured in accordance with illustrative embodiments of the invention. The respirator mask 10 is a half-mask type and is shown with attached disc-shaped particle filters. The mask could be, for example, a GERSON SIGNATURE SERIES (Louis M. Gerson Co., Inc, Middleboro, Mass.) low maintenance dual cartridge respirator half-mask that conforms with NIOSH standards (42 CFR 84). Such masks are lightweight, have elastomeric nonallergenic facepieces, a cradle suspension, and easily adjustable headstraps, and allow the use of glasses or safety goggles. Of course, discussion of the mask in shown in FIG. 1 is illustrative; other masks may be used.

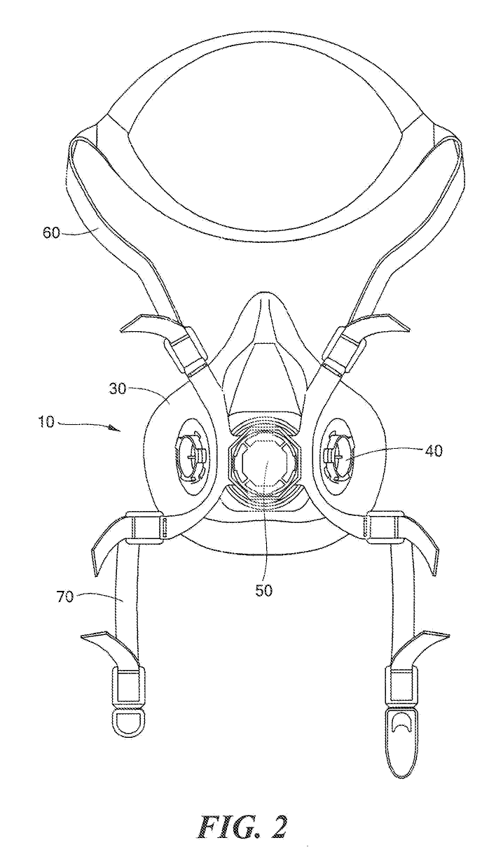

FIG. 2 schematically shows a front view of a half-mask respirator. The respirator has a resilient face-piece 30 that is securable to the face of a user 20 by means of a pair of adjustable straps 60 and 70. The face piece 30 has two inhalation ports 40 with connectors for connecting to the vapor or particle filters. The inhalation ports 40 may include one-way valves that allow air to be inhaled, but not exhaled. Air is exhaled through an exit port 50, which also may include a one-way valve oriented to prevent inhalation through the exit port. As a result, inhaled air should pass through the inhalation ports and attached filters.

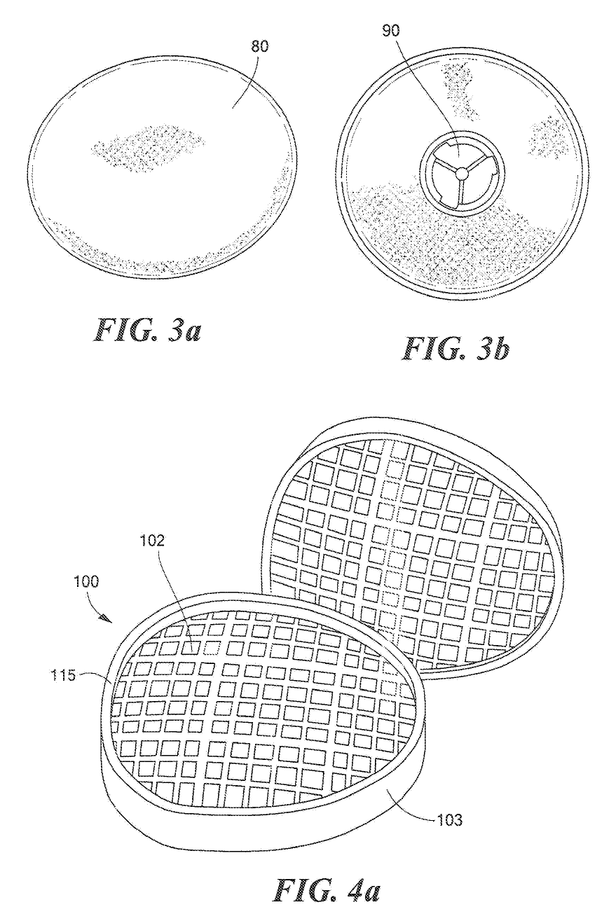

FIG. 3a and FIG. 3b respectively show top and bottom views of a quick-connect particle filter 80 for filtering particles. The quick-connect particle filter 80 is disc shaped and removably attaches to a mask 10. The quick connect particle filter 80 may include a female connector 90 for connecting to male connectors of an inhalation port 40 of the mask 10. The quick-connect particle filter 80 may be, for example, a NIOSH-approved P100 filter, such as a Gerson XP 100 filter (Louis M. Gerson Co., Inc, Middleboro, Mass.). When attached to the mask 10, the quick-connect particle filter 80 removes ambient particles from inhaled air.

FIG. 4a shows a top-view of a vapor filter cartridge 100 that may be attached to the mask 10 to protect a user from chemical vapors, such as volatile organic chemicals, acid vapors, or other vapors. Activated charcoal (not shown) or other adsorbent chemical media are contained within a body 103 of the cartridge 100. Vents 102 allow air to pass into and through the body 103 from the environment. A filter media retaining structure, such as a fabric, contains the filter media within the body 103. The body also has a lip 115 to secure a retainer, such as that shown and discussed with respect to FIG. 7, below. For reasons of economy and ease of assembly, the body 103 may be constructed of two injection-molded components. Other constructions may also be used, and may include thermoformed components.

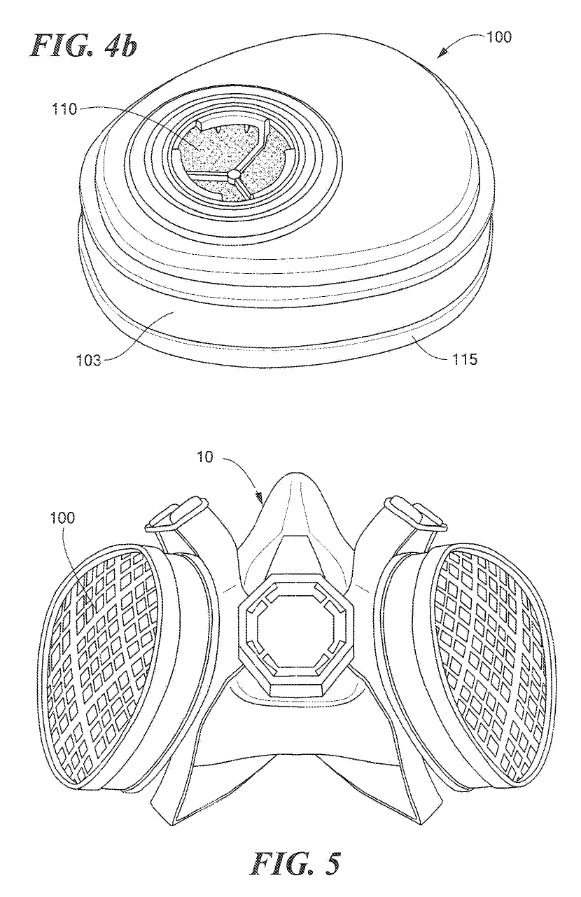

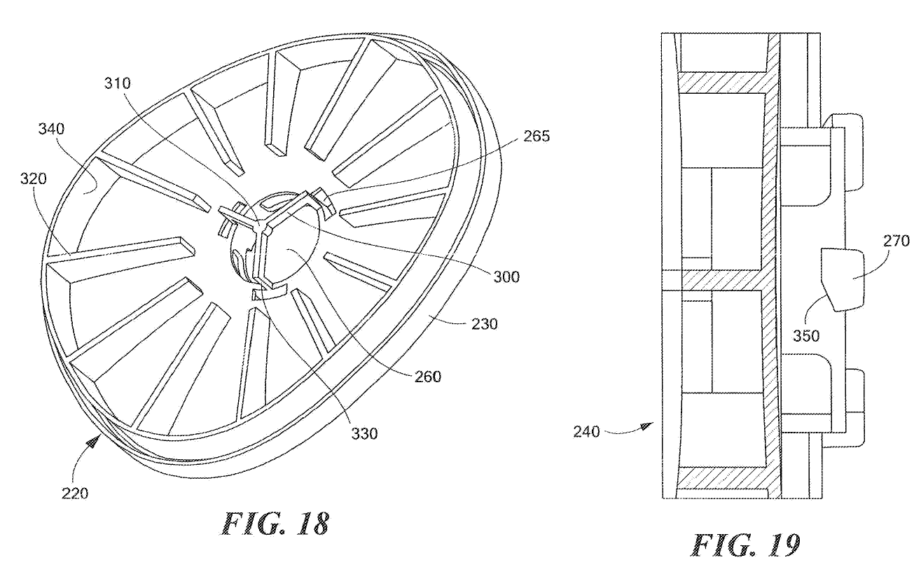

FIG. 4b shows a bottom view of the vapor filter cartridge 100. It should be noted that the term “bottom” is used herein to represent the side of a component that faces the mask 10. In a corresponding manner, the term “top” is used herein to represent the side of a component that faces a particle filter, when used. The bottom of the vapor filter cartridge 100 includes a female connector 110 for connecting to a male inhalation port 40 of the mask 10. As a result, the air drawn in during an inhalation by a user 20 passes through media held within the body of the vapor filter cartridge 100, thereby protecting the user from ambient vapors. As an example, FIG. 5 shows a mask 10 with two vapor filter cartridges 100 removably connected to the mask's inhalation ports. In order to increase airflow through the adsorbent media, internal ridges (not shown) may project inwardly from the interior surface of the bottom side of vapor filter to promote distribution of the inhaled air over the entire surface area of the cartridge 100. The ridges also apply pressure to the retaining fabric, thereby compacting the adsorbent media to prevent to prevent channeling or openings in the media, through which unfiltered air could otherwise pass. The ridges are spaced apart from each other to allow for a high degree of airflow throughout the vapor filter cartridge 100. Similar ridges are described below with reference to FIG. 18 (item 320).

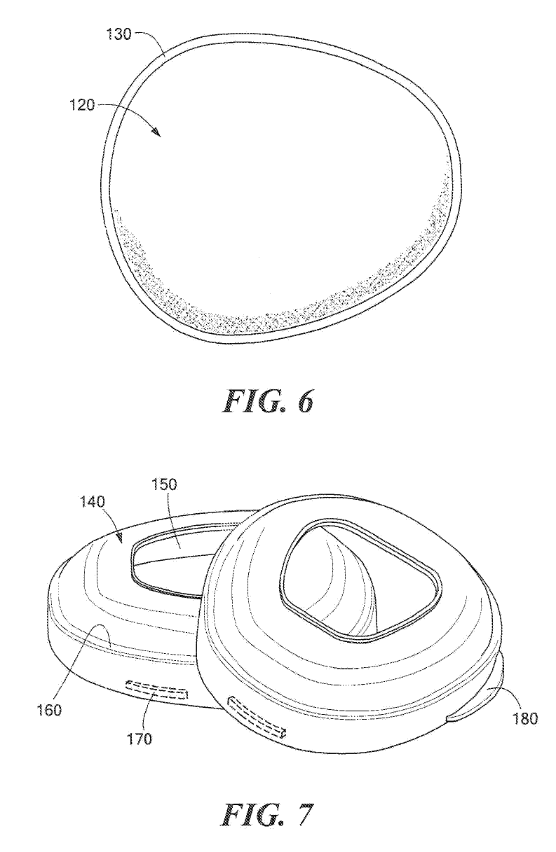

Under some circumstances, a user 20 may wish to be protected from both ambient particles and ambient vapors. To accomplish this, a particle filter pad 120, such as that shown in FIG. 6, may be secured to a vapor filter cartridge 100. The particle filter pad 120 may be a HEPA filter that is similar in function to the particle filter 80 of FIGS. 3a and 3b. One difference, however, is that the pad 120 has no integral connector. Instead, a retainer (FIG. 7) sealingly holds the periphery 130 of the pad 120 against a lip 115 of the vapor filter cartridge 100. Accordingly, when coupled, the assembly removes both vapor and particles from inhaled air.

FIG. 7 shows a retainer 140 that couples the filter pad 120 to the vapor filter cartridge 100. The retainer 140 has a central passageway 150 to allow airflow from the environment, through the combined vapor and particle filter, and to the user 20 during inhalation. A retainer sealing surface 160 presses against the periphery 130 of the pad 120 to seal it to the vapor filter lip 115. This prevents air from entering a gap between the pad 120 and the lip 115 and thereby bypassing the filter pad 120. An internal tab 170 secures the retainer 140 to the underside of the vapor filter lip 115 to prevent the pad 120 from moving, and to apply a force sufficient to seal the pad 120 to the lip 115. External side-tabs 180 provide convenient points for a user to apply force when attaching the pad 120 and retainer 140 to a vapor filter cartridge 100.

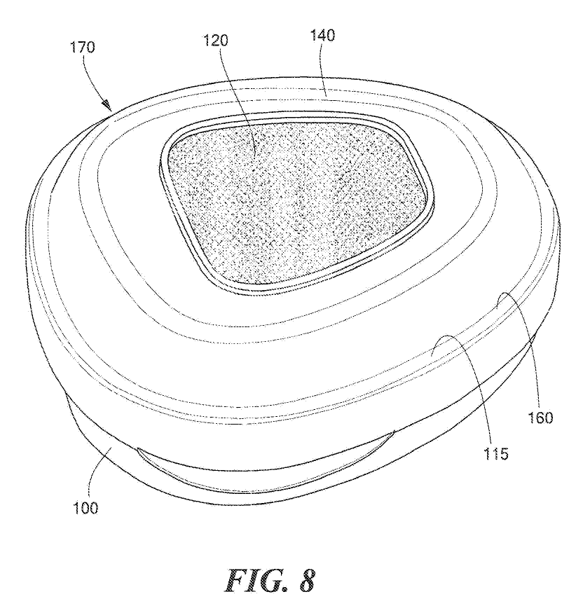

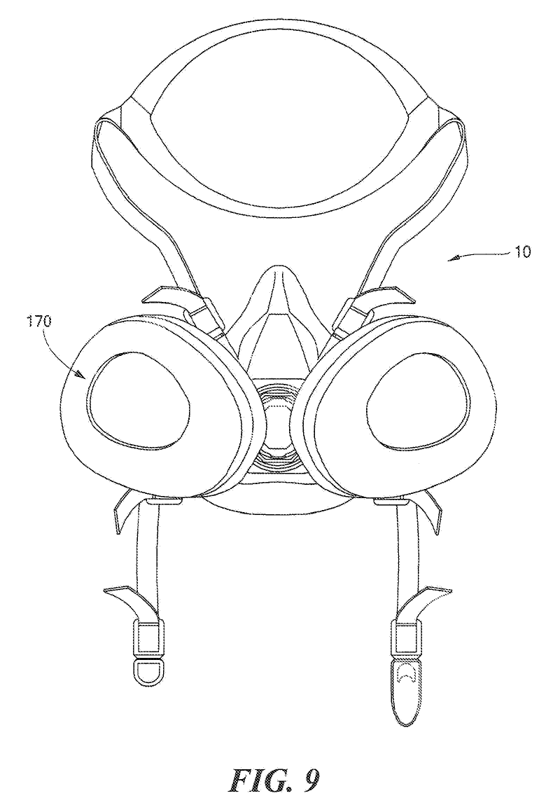

FIG. 8 shows a close-up view of an example of a combined filter assembly 170 having a vapor filter cartridge 100 with a particle filter pad 120 securely attached by a retainer 140. In a corresponding manner, FIG. 9 shows the mask 10 with two combined filter assemblies 170.

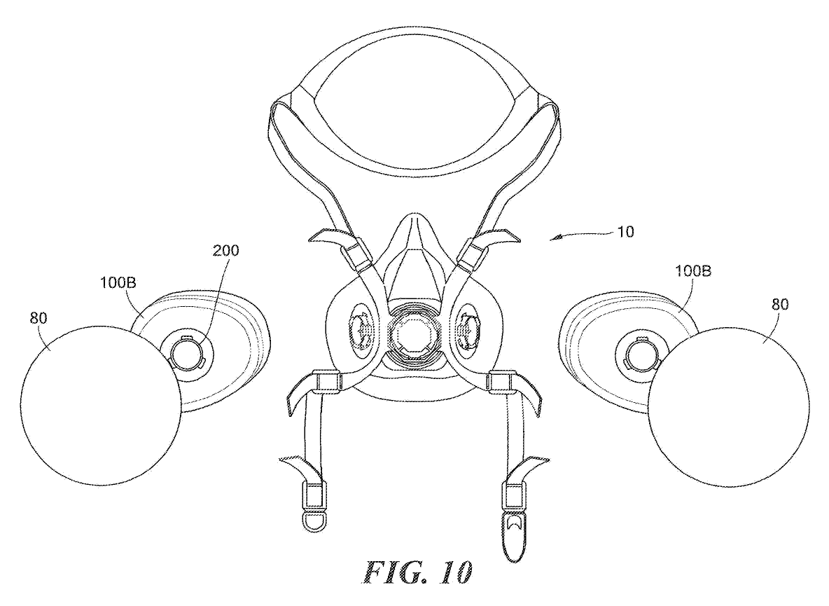

In accordance with illustrative embodiments of the invention, a vapor filter cartridge 100B has a quick-connect adaptor for coupling with a corresponding quick-connect adapter on the filter pad 80. Accordingly, a user 20 may rapidly and easily couple the two components together without the need for the retainer 140. To that end, FIG. 10 schematically shows an exploded view of a mask and filter system for filtering airborne vapors and particles. The filter system includes the above noted quick-connect vapor filter cartridge 100B, which has a top connector for connecting with a quick-connect particle filter 80. In illustrative embodiments, the top connector is adapted to couple with conventional mating interfaces of the particle filter 80. Accordingly, such a connection permits use with an off-the-shelf particle filter 80. When connected to the mask, the quick-connect vapor filter cartridge 100B should filter vapors from environmental air. As noted above, when the vapor filter cartridge 100B is coupled with the particle filter 80, the assembly will protect a user 20 from both vapors and particles.

Although the quick-connect vapor filter cartridges 100B are capable of attachment to quick-connect particle filters 80, there may be times when it is desirable to use filter pads 120 as an alternative. Filter pads 120 are typically less expensive than tightly coupling, higher efficiency (e.g., HEPA or P100) particle filters, such as quick-connect filter 80, but are not suited for use in certain environments. Thus, the quick-connect cartridges 100B allow for improved flexibility and economy.

FIG. 11 shows an exploded view of a respirator system that uses quick-connect vapor filter cartridges 100B with particle filter pads 120 to provide both vapor and particle protection. In this case, the filter pad 120 may be generally co-circumferentially overlaid on the quick-connect vapor filter cartridge 100B to cover the integral connector. The filter pad 120 may then be secured by the retainer 140 by compressing the circumference of the filter pad 120 between the sealing surface 160 of the retainer and the circumferential lip 115 of the vapor filter cartridge 100B in the manner similar to that described above with reference to FIG. 7.

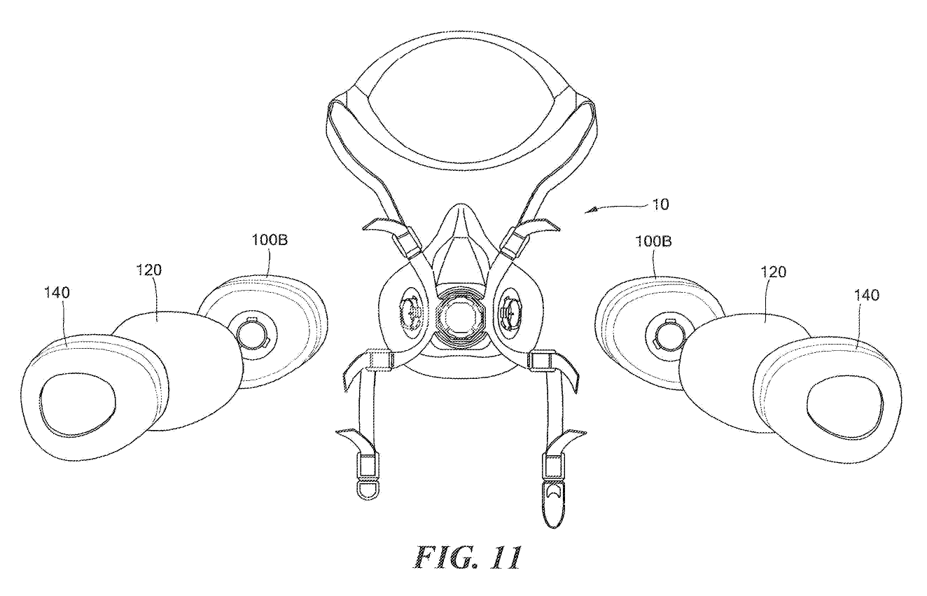

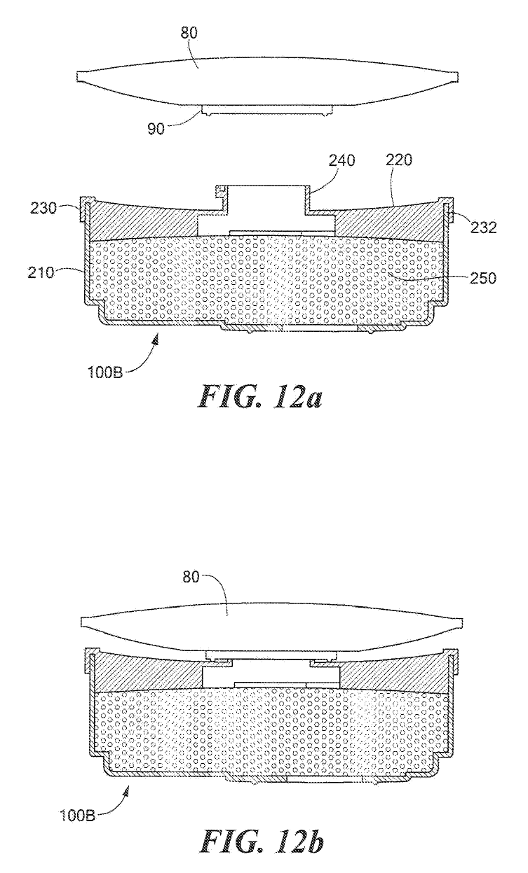

FIG. 12a shows a sectional view of an uncoupled quick-connect vapor filter cartridge 100B/ quick connect particle filter 80 combination, while FIG. 12b shows a sectional view of a quick-connect vapor filter cartridge 100B coupled with a quick-connect filter 80. In illustrative embodiments, the vapor filter cartridge 100B is comprised of two injection-molded plastic pieces: a bottom piece 210 secured to a top piece 220. A body cavity 250 formed by assembling the pieces 210 and 220 holds the vapor adsorbing media. The bottom piece 210 sealingly fits into a slot 232 in the top piece 220 adjacently interior to a circumferential lip 230. The top piece 220 also includes a male connector 240 for coupling with a female connector 90 of the quick-connect particle filter 80. An elastomeric gasket (not shown) may be placed coaxially around the cylindrical member (FIG. 17) of the male connector 240 to provide a more effective seal between the vapor filter cartridge 100B and particle filter 80. The male connector 240 and female connector 90 may provide a sufficiently airtight connection to retain the full efficacy of quick-connect P100 (HEPA) particle filters 80. Accordingly, a bayonet connection may be used, as described below. Alternatively, a threaded connection may be used. As described with respect to FIG. 17, the male connector 240 may have one or more air openings (item 262 of FIG. 17) in a side wall; these air openings may be sealingly blocked upon connecting to the female connector 90 of the quick connect particle filter 80.

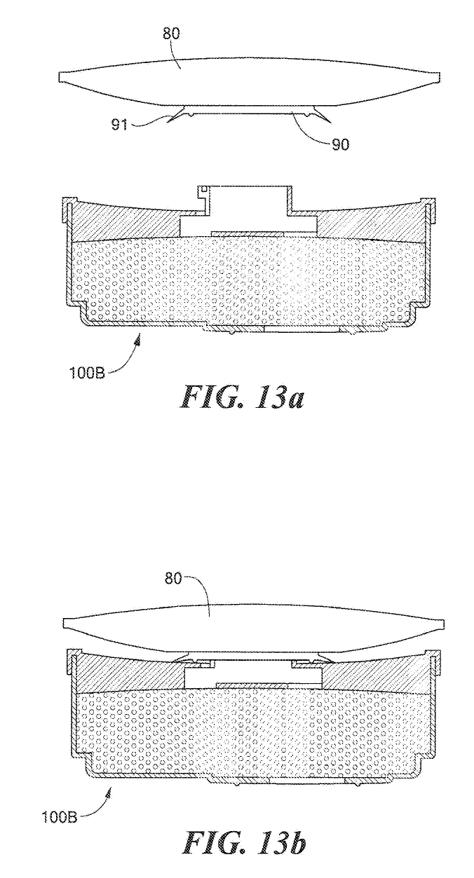

FIGS. 13a and 13b show a sectional view of an alternate particle filter 80 that includes an integral sealing flange 91; FIG. 13a shows the particle filter 80 and the quick connect vapor filter cartridge 100B in a disassembled mode, while FIG. 13b shows a the particle filter 80 and the quick connect vapor filter cartridge 100B in an assembled mode. By integrating the annular flange 91 into the particle filter 80, the use of a gasket may be obviated, further reducing costs and increasing convenience. During connection of the particle filter 80 and the cartridge 100B, the annular flange 91 sealingly seats directly upon the upper surface of the quick connect vapor cartridge 100B. The flange 91 may extend past the rest of the female connector 90, so that coupling of the particle filter 80 and cartridge 100B causes the flange 91 to deform upon connection so that it applies a sealing force upon the upper concave surface of the cartridge 100B. Accordingly, the flange 91 may extend radially outward from the center of the female connector 90 and be tapered so that its radial terminus is sufficiently thin to be resiliently deformed during connection.

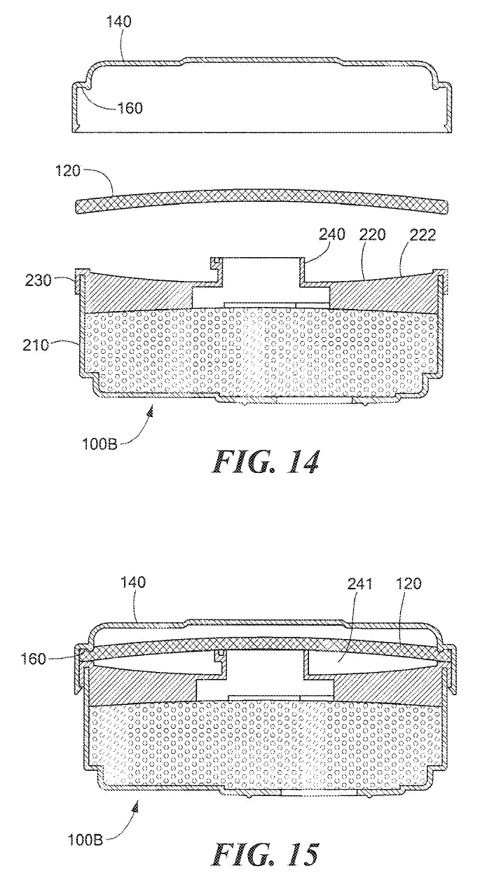

FIGS. 14 and 15 respectively show sectional coupled and uncoupled views of the quick-connect vapor filter cartridge 100B when used with the filter pad 120 and the retainer 140. When coupled, the filter pad is positioned generally co-circumferentially with the circumferential lip 230. As a result, it will cover the male connector 240. An internal tab 170 secures the retainer 140 to the underside of the circumferential lip 230 of the top piece 220, thereby providing the requisite force for the sealing surface 160 to sealingly secure the filter pad 120 to an upper surface of the lip 230. An upper surface 222 of the top piece 220 may be concave to increase the size of an air space 241, thereby increasing airflow through the cartridge 100B when used with a filter pad 120 and retainer 140, thereby reducing breathing resistance. Further reductions in breathing resistance may be achieved by providing air openings (item 262 of FIG. 17, below) in the side wall of the male connector.

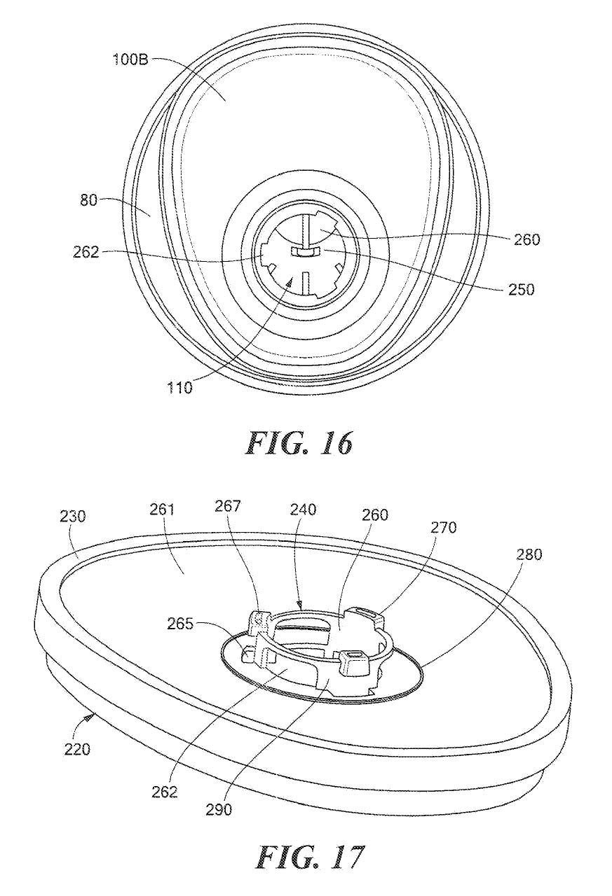

FIG. 16 shows a bottom view of a quick-connect vapor filter cartridge 100B when coupled to a quick-connect particle filter 80. The female connector 110 includes a central aperture 260 with three rectangular slots 262 for accepting corresponding bayonets of a male connector associated with the inhalation port 40 of a mask 10. The central aperture 260 in the male connector of the top piece is offset from the central aperture 250 of the female connector 110 to provide a longer path of airflow through the body. Consequently, this larger path should increase the vapor filtering ability of the vapor filter cartridge 100B.

FIG. 17 shows a top view of a top piece 220 of a quick-connect vapor filter cartridge 100B and its circumferential lip 230 and male connector 240 with a central aperture 260. The male connector 240 has a cylindrical member 290 that supports three bayonets 270, which are complementary in structure to corresponding grooves in a female connector (item 90 of FIG. 3b) of the quick-connect particle filter 80. The grooves are similar in structure to the grooves 260 (of the bottom piece 210), which are shown and described with reference to FIG. 16. The underside of the bayonets are sloped (as described below with reference to FIG. 19) so that when a user 20 inserts the bayonets 270 into the corresponding grooves of the particle filter 80 and rotates the particle filter 80 relative to the vapor filter cartridge 100B, a rotational force is orthogonally coupled into a clamping force. The rotational motion also sealingly closes air openings 262 in the cylindrical member 290. Upon rotation, a ridge 280 that coaxially encircles the base of the cylindrical member 290 transmits a sealing force to a resilient gasket (not shown) positioned between the vapor filter cartridge 100B and the particle filter 80. When the vapor filter cartridge 100B is used with a filter pad 120 and a retainer 140, air openings 262 in the cylindrical member 290 increase airflow into the air space 241; vapor filtration efficiency is thereby increased and breathing resistance thereby reduced. A hole 265 located beneath the bayonet 270 allows the bayonet 270 and top piece 220 to be produced as a single molded part by allowing a mold structure to pass through the flat portion 261 of the top piece 220. Recesses 267 in the bayonets 270 create a uniform wall thickness to reduce the likeliness of sagging and deformation of the bayonets 270 when the part is injection molded.

FIG. 18 shows a bottom view of the top piece 220 of a quick-connect vapor filter cartridge 100B. Radial ridges 320 extend inwardly from an inner wall 340 toward the aperture 260 to create an air space above the vapor adsorbing media, thereby improving the distribution of airflow through the vapor filter cartridge 100B. Increasing the airflow distribution should increase filtration efficiency of, and reduce the breathing resistance from, the vapor filter cartridge 100B. The ridges 320 also press against the retaining fabric that holds the vapor filter media to compact the media and increase filtration efficiency. For the same reasons, ridges (not shown) may be included in the bottom piece 210 of the vapor filter cartridge 100B. A radial support structure 300 of the top piece 220 includes multiple arms positioned around a central hub 310. The arms are attached to the top piece 220 via perpendicular projections 330. The radial support structure 320 and radial ridges 320 hold vapor filter media (e.g., activated carbon covered with a sheet of fabric) firmly in place within the body of the vapor filter cartridge 100B when assembled.

FIG. 19 shows a sectional view of the male connector 240 of the top piece 220. The bayonets 270 have a sloped underside 350, which, upon insertion into and rotation within corresponding grooves of a female connector, slidingly couples a user-applied rotational force of the vapor filter cartridge 100B relative to the quick-connect particle filter 80 into an inwardly compressing force for sealingly coupling the two filters. Generally, similar bayonet structures and principles may be used for the male connector on the port or ports 40 of the mask 10 and the female connector 110 of the bottom piece 210 of the quick-connect vapor filter cartridge 100B.

It should be noted that the mask described above is not meant to limit all embodiments of the invention. Instead, the filters described in various embodiments of the invention may be used with a wide variety of other respirator masks that are single-cartridge, dual-cartridge, half-masks, full-masks, etc. In fact, the filters may be used with devices that are not designed to be worn on the face.

It should also be recognized that the male/female polarity of the various connections may be switched, if desired, and the above-described embodiments of the invention should be understood not to be limited by a particular polarity or type of mount.

Accordingly, illustrative embodiments of the invention permit use of only three parts; namely, the mask 10, the vapor filter cartridge 100, and the particle filter 80. The system does not require use of the retainer 140, thus simplifying connection. The system also uses fewer parts, and therefore costs less. As discussed above, however, illustrative embodiments still may use either or both the particle filter 80 with its quick-connect assembly, and the filter pad 120 secured by means of the retainer 140.

Although various exemplary embodiments of the invention have been disclosed, it should be apparent to those skilled in the art that various changes and modifications can be made that will achieve some of the advantages of the invention without departing from the true scope of the invention. These and other obvious modifications are intended to be covered by the appended claims.

What is claimed is:

1. A respirator cartridge comprising:
a body having a cavity for vapor filter media, the body having a integral filter connector for connecting with a particle filter.

2. A respirator according to claim 1, wherein the filter connector is a quick-connect filter connector.

3. A respirator cartridge in accordance with claim 1 wherein the body further comprises an integral mask connector for connecting with a respirator mask.

4. A respirator cartridge in accordance with claim 2, wherein the filter connector is a quick-connect filter connector.

5. A respirator cartridge in accordance with claim 2, wherein the mask connector is a quick-connect filter connector.

6. A respirator cartridge in accordance with claim 2, wherein both the filter connector and the mask connector are quick-connect filter connectors.

7. A respirator cartridge in accordance with claim 2, wherein the filter connector is a male connector and the mask connector is a female connector.

8. A respirator cartridge in accordance with claim 2 wherein the filter connector is disposed on a first side of the body and the mask connector is disposed on a second side of the body.

9. A respirator cartridge in accordance with claim 3, wherein the first and second sides are opposingly located.

10. A respirator cartridge in accordance with claim 1 further comprising a gasket for sealing attachment of the body to the particle filter.

11. A respirator cartridge in accordance with claim 1 further comprising a circumferential lip for receiving a particle filter, wherein co-circumferential attachment of the particle filter causes air-flow through the first side of the body to pass through the particle filter.

12. A respirator cartridge in accordance with claim 11 wherein the lip is structured to receive a particle filter retainer having a central air passage, a circumferential sealing surface for sealing the particle filter to the lip, and a locking feature for securing the filter cartridge retainer to the respirator cartridge.

13. A respirator cartridge in accordance with claim 1, wherein the body is constructed from a first piece and second piece.

14. A respirator cartridge in accordance with claim 13, wherein the first piece includes a male connector and the second piece includes a female connector.

15. A respirator cartridge in accordance with claim 13 wherein the first piece and the second piece further comprise internal ridges for holding the vapor filter media.

16. A respirator cartridge in accordance with claim 1, wherein the body has an integral male connector and an integral female connector.

17. A respirator cartridge in accordance with claim 16 wherein the body is constructed of an injection molded thermoplastic and includes a male bayonet mount structure and a female bayonet mount structure.

18. A respirator cartridge in accordance with claim 17 wherein the body further comprises a threaded mount.

19. A respirator cartridge in accordance with claim 17 wherein the male bayonet mount structure comprises:
a projecting cylindrical member with a central aperture for the flow of fluid in an axial direction therethrough when the mount is in either a coupled or uncoupled state;
the cylindrical member having an opening in a side wall thereof for allowing passage of fluid in a transverse direction when the male bayonet is in an uncoupled state, the opening being blocked when the mount is coupled to a complementary female bayonet mount.

20. A respirator cartridge in accordance with claim 17 having an upper concave surface surrounding the male bayonet structure for increasing the size of an air gap when a filter pad is positioned above the bayonet structure.

21. A filter system for use with a respirator mask, the system comprising:
a vapor filter cartridge having a body with a first integral connector; and
a particle filter having a second integral connector, the first integral connector being removably connectable with the second integral connector.

22. A system in accordance with claim 21 wherein the first integral connector is sealingly connectable with the second integral connector.

23. A system in accordance with claim 22 further comprising a gasket for providing a seal when the first and second integral connectors are connected.

24. A system in accordance with claim 23 further comprising a respirator mask coupled with the vapor filter cartridge.

25. A system in accordance with claim 24 wherein the body is composed of a first piece and a second piece.

26. A system in accordance with claim 21, wherein the second connector includes an annular flange adapted to sealingly seat upon the vapor filter cartridge upon connection of the first and second integral connectors.

27. A respirator cartridge comprising:
(a) means for containing a vapor filter media;
(b) means for coupling the containing means to a respirator mask;
(c) means for coupling the containing means to a particle filter, the particle filter having an integral connector.

28. A respirator cartridge in accordance with claim 27, further comprising:
(d) sealing means for sealably accepting a filter pad.

29. A respirator cartridge in accordance with claim 28, further comprising
(e) securing means for receiving a filter pad retainer to maintain the filter cartridge and holding means in sealing arrangement.

30. A method comprising:
(a) providing a cartridge having a body for holding vapor filter media, the cartridge having a first integral connector;
(b) providing a particle filter having a second integral connector; and
(c) attaching the first and second integral connector thereby establishing fluid communication between the cartridge and the particle filter.

31. A male bayonet mount comprising:
a projecting cylindrical member with a central aperture for the flow of fluid in an axial direction therethrough when the mount is in either a coupled or uncoupled state;
the cylindrical member having an opening in a side wall thereof for allowing passage of fluid in a transverse direction when the male bayonet is in an uncoupled state, the opening being sealingly occluded when the mount is coupled to a complementary female bayonet mount.

32. A particle filter comprising a particle filtration medium sealed to an integral female connector adapted for attachment to a male connector of a vapor filter cartridge, wherein the female connector includes a flange adapted to sealingly seat upon the vapor filter cartridge upon connection of the particle filter and the vapor filter cartridge.
